(19) United States
(12) Patent Application Publication
(10) Pub. No.: US 2002/0171684 A1
(43) Pub. Date: Nov. 21, 2002

(54) Using icon-based input cues

(76) Inventors: Eric P. Christianson, Meridian, ID (US); Rhonda A. Grindstaff, Boise, ID (US); Michael W. Smith, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/859,839

(22) Filed: May 16, 2001

(51) Int. Cl. G06F 3/14

(52) U.S. Cl. 345/835; 345/840

(57) ABSTRACT

The use of an icon-based input cue or cues to facilitate the operation and user-friendliness of a device such as a printer, copier, scanner, facsimile machine, and the like. The icon-based input cue or cues which correspond to active device operations available to the user are displayed on the device display to visually inform a user of the device operations available to the user. The icon-based input cues may include graphics, icons, text, or any combination thereof.

### FIELD OF THE INVENTION

The present invention relates generally to display devices, and more particularly to the use of icon-based input cues with display devices to visually inform a user of the device options available to the user.

### BACKGROUND OF THE INVENTION

Our society has become a visual society. Symbols and pictures are used to express ideas or directions. Symbols and pictures are especially useful where communication may be difficult, such as in multi-lingual applications. As the business world expands across international boundaries and the prevalence of home computing increases, the use of visual cues will become more important. As visual cues are used more frequently, new methods and devices must be created to offer the advantages of such cues.

The visual presentation of data or information is not new. For example, many computer programs are both text and image based. A visual image appearing on a computer display is associated with a program or a function that the computer may be able to perform. For example, icons are arranged in series on a toolbar, the icons providing visual links or buttons which allow a user to perform various functions within a computer program by selecting the icon. The selection of a visual tool or button executes a program or function, allowing the user to carry out a task. Similarly, visual cues have been integrated with touch-sensitive displays which allow a user to physically select a visual cue by touching a portion of the touch-sensitive display corresponding to the desired visual cue. A good example of this type of visual cue interaction is found in many of the high-end digital copiers on the market today. A large touch-sensitive liquid-crystal display visually expresses the options available to the user. A user may touch the portion of the touch-sensitive display to choose the desired function. The copier then executes the functions corresponding to the icon or visual image chosen by the user.

Although visual images and icons have been integrated with computers and touch-sensitive displays, icons are not used with many other display screens. For example, display screens found on many printers, copiers, scanners, and facsimile machines are only capable of displaying text. A typical facsimile machine includes a display screen capable of displaying textual instructions or commands. However, the length of the displayed message is often times limited by the textual spaces available on the display. A typical display usually includes one or two rows of character positions, each row containing between about fifteen and twenty character positions. A typical character position display 110, as found in the art, is illustrated in FIG. 1. A single character may be displayed in each character position 120 of display 110. One of the problems with such a display 110 is that the amount of information which can be communicated is limited by the number of characters which can be displayed in the given number of character positions 120. This often prevents the display of instructions which are sufficient to allow a user to operate the device without the additional help of a handbook.

An additional problem arises where the device using such a textual display is used in multi-lingual situations because language specific instruction sets must be created for the display. For example, a facsimile machine made in the United States and shipped to Japan must be capable of displaying messages in Japanese, or even in English and Japanese. This creates problems. Multiple language sets or programs must be created and installed on machines which are not destined for a specified lingual area. Furthermore, instruction handbooks must be printed in multiple languages to assure proper operation of the device.

In order to overcome the inefficiencies and user difficulties associated with current device displays, the present invention integrates icon-based cues with displays in devices such as copiers, printers, scanners, facsimile machines, and the like.

### SUMMARY OF THE INVENTION

The present invention involves icon-based input cues and methods of using icon-based input cues with display devices. The use of icon-based input cues in smaller display devices, such as those found on printers, copiers, scanners, facsimile machines, and the like, provides a mechanism by which additional information may be communicated to a user by the limited display area available with such devices.

An icon-based input cue is a visual cue, instruction or picture displayed on a display of a device such as a printer, copier, scanner, facsimile machine, and the like. The icon-based input cue may be solely an icon, graphical image, or picture which communicates a message to a user. An icon-based input cue may also be a combination of a text string or message with at least one icon, graphical image, or picture to communicate a message to a user.

In one embodiment of the present invention icon-based input cues such as a set of visual cues, or graphical icons, may be displayed in addition to the standard character positions available on the display. The icons of the icon-based input cues may be displayed alone or in combination with other icons, textual instructions, or data. For example, the display may be separated into two different regions, a character position region and an icon display region. Within the character position region, a row of character positions is available for displaying messages or accepting data input. Similarly, various icons may be displayed in the icon display region to provide a user with cues on how to operate the device or enter data into the character position regions. The icons may be displayed alone, or in combination with text characters to communicate a message to a user.

In another embodiment of the present invention, the entire display may be a pixel based display such that icons and characters may be displayed in virtually any desired fashion. Additionally, the font size of displayed text or the size of icons may be adjusted to provide emphasis to certain portions of the messages being displayed or to provide the user with a customized display.

The present invention may be implemented by storing icons or image files within a memory of a device. The icons typically correspond to the control, selection and input keys of the device which a user may select to perform specific functions. If a particular control, selection or input key would cause the device to perform a programmed function, the necessary icon is displayed on a display of the device. The user is thereby visually informed that they may choose the control, selection or input key corresponding to the displayed icon to perform a function with the device. Thus, icon-based input cues visually aid in the operation of a device and improve the user-friendliness of any device employing the present invention.

### DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 illustrates a common character position display for a device such as a printer, copier, scanner, facsimile machine, and the like, as found in the prior art;

FIG. 2 illustrates a display and control panel as may be found with a device utilizing the icon-based input cues of the present invention;

FIG. 3 illustrates the display illustrated in FIG. 2, defining one possible layout of character positions, text regions, and icon regions;

FIG. 4 illustrates a representative example of the use of icon-based input cues with a display;

FIG. 5 illustrates a representative example of the incorporation of the icon-based input cues with a device such as a copier/scanner/facsimile machine;

FIG. 6 illustrates the display of FIG. 5 following a series of control, selection and input key operations;

FIG. 7 illustrates a block diagram of a display in communication with components to carry out the embodiments of the present invention; and

FIG. 8 illustrates a block diagram of an alternate embodiment of the present invention.

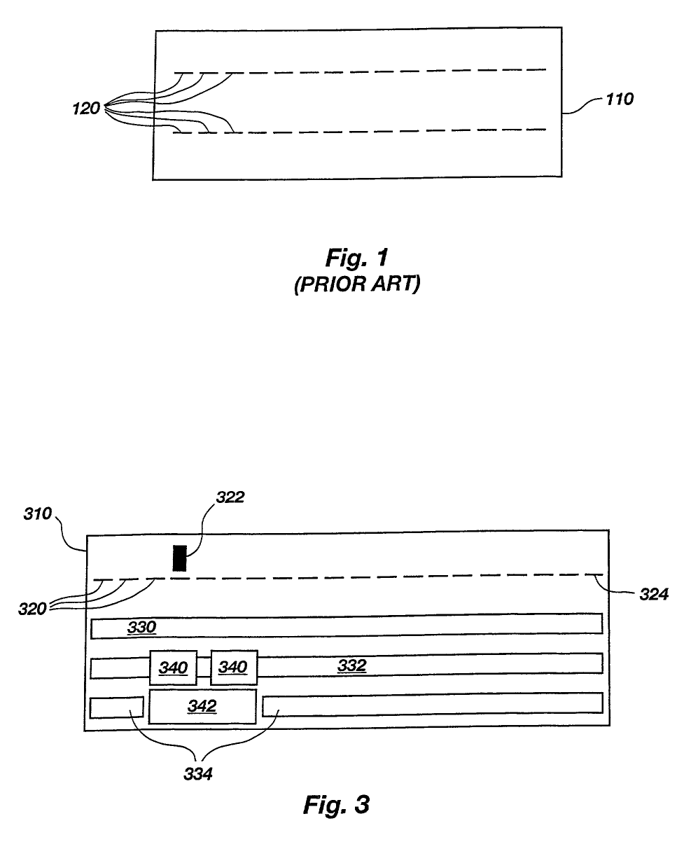

### DETAILED DESCRIPTION OF THE INVENTION

The present invention involves the use of icons with displays, and more particularly, the use of icon-based input cues to visually communicate instructions or directions to a user of a device employing the present invention.

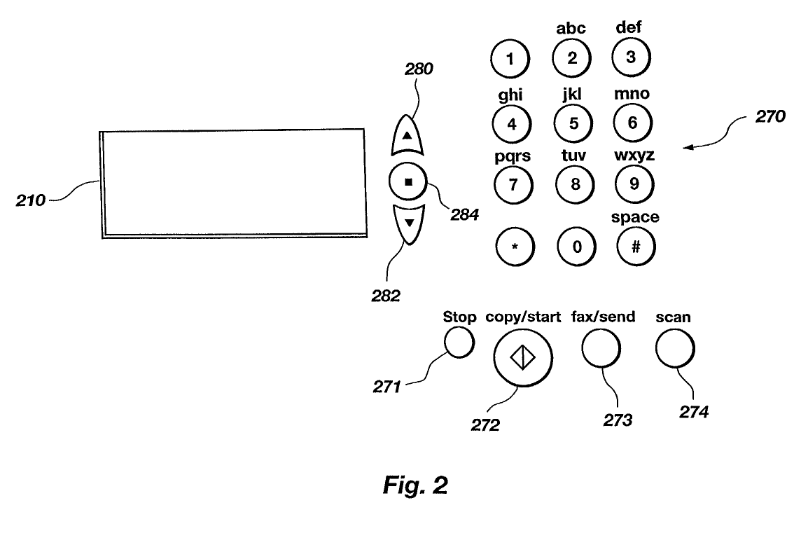

Illustrated in FIG. 2 is a combination of a display and a control panel as might be used with the present invention. In this particular illustration, the display 210 and control panel 270 of a combination facsimile/copy/scan machine is depicted. It is understood, however, that use of the present invention is not limited to such machines, but rather, may be integrated with any device employing a display in which it would be advantageous to incorporate icon-based input cues, including devices such as printers, copiers, scanners, facsimile machines, and the like.

Preferably, the display 210 of FIG. 2 is a bit map display capable of displaying icons or graphics. A bit map display is a display consisting of a plurality of pixels, or dots, to which colors or shades of gray may be assigned. An image is displayed on the bit map display by assigning certain pixels colors or shades of gray according to a bit-mapped image stored in a memory of the device. A bit-mapped image consists of a set of data which defines the colors or shades of gray for a certain number of pixels in the display. The use of bit mapped images and displays is well known in the art. Any display, however, capable of displaying both text and graphics may be used with the present invention. The display 210 may be color or grayscale, active matrix or liquid crystal display, or other type of display as known in the art.

The control panel 270 illustrated in FIG. 2 includes a number of control, selection and input keys, which together, or individually, may be referred to as function keys. The “Stop” key 271, the “copy/start” key 272, the “fax/send” key 273, and the “scan” key 274 in FIG. 2 are each examples of control keys which allow a user to operate the device in its intended manner. The selection keys in this example include a forward navigation key 280, a reverse navigation key 282, and an “ok” key 284. These keys allow the user to manipulate or select data appearing on display 210 and to carry out operations or controls using the selected data. The input keys allow a user to input data or commands into the particular device being used. In this example, the input keys include a standard twelve key numeric keypad having the numbers 0 through 9 and the symbols “*” and “#” as typically found in the art. As illustrated, some of the input keys are also associated with letters printed on or above the key to which the letters are associated. For example, the “5” key is also associated with the letters “j” “k” and “l.” Similarly, the “#” key and the “*” key may be associated with characters or symbols commonly used with the display, such as a character “space” associated with the “#” key in this example.

Illustrated in FIG. 3 are the text and graphics regions which may exist on a display 310 used with the present invention, such as display 210 of FIG. 2. The display 310 of this particular embodiment is divided into character positions, text regions and graphic regions. Although a specific regional layout is depicted in FIG. 3, the use of bit-mapped and other such displays allows the regions on the display 310 to be positioned in different locations on the display according to the requirements or programming of the device. The region outlines illustrated in FIG. 3 are not normally visible to a user, but are visually defined in FIG. 3 to help further explain the present invention.

In FIG. 3, twenty visible character positions 320 are located near an upper portion of the display 310. Each character position 320 may store or be occupied by a single character, symbol, or space. An active cursor 322 occupies a single visible character position 320 on the display 310. A text region 330, an overlaid text region 332 and a broken text region 334 are also illustrated as part of FIG. 3. Icon regions 340 overlie the overlaid text region 332 and large icon region 342 is depicted between two portions of broken text region 334. It is understood that additional regions (not shown) may also be included on the display as desired.

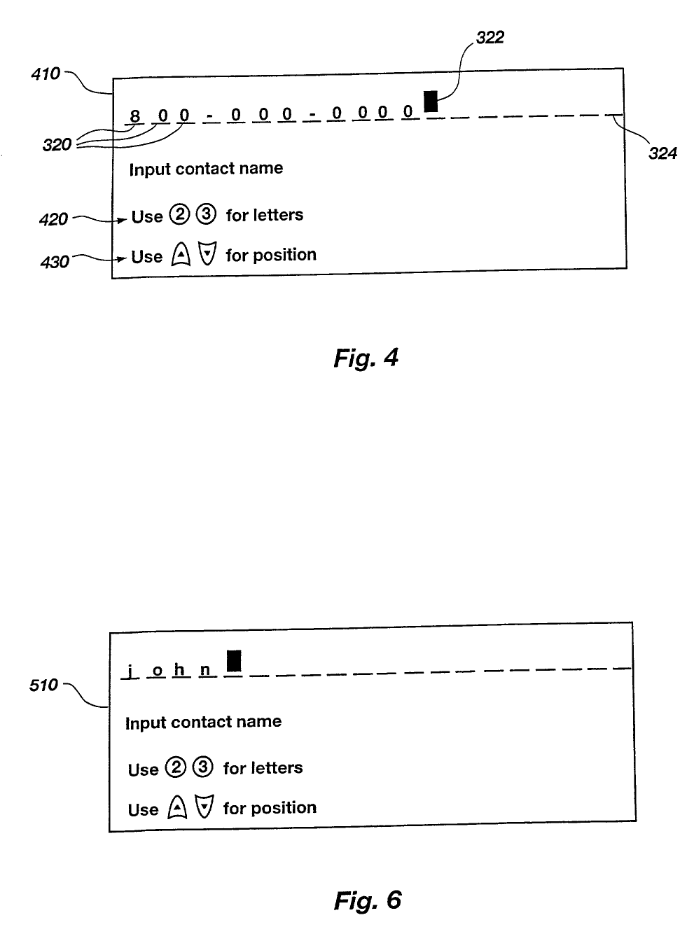

Character positions 320 display data or text entered by a user. For example, if display 310 is part of a facsimile machine and a user requests a list of frequently dialed numbers, the numbers are visually displayed within the visible character positions 320. Each character of the number occupies a single character position 320 as illustrated in FIG. 4. The number “800-000-0000” is displayed in the first twelve character positions 320 of display 410. Each number or symbol (the “-”) occupies one, and only one, character position. If the data being displayed in the character positions 320 has more than nineteen characters, then the characters are stored in a memory of the device and the last nineteen characters of the data are displayed in the character positions 320. One character position 320, typically the last character position 324, always remains open or empty so that additional characters may be truncated to the data displayed in the character positions 320. Although twenty character positions 320 are illustrated in display 310, it is understood that additional or fewer character positions 320 may be displayed in other embodiments of the present invention.

Information or data is truncated to data appearing in the character positions 320 by using the input keys and selection keys of the device. The active cursor 322 appears in the first available, or non-occupied, character position 320. In FIG. 4, the active cursor 322 appears in the thirteenth character position 320 following the displayed number. If the displayed data occupies more than nineteen character positions 320, the active cursor 322 is displayed in the twentieth, or last character position 324. The use of character positions 320 and an active cursor 322 to represent a character position 320 capable of accepting data is well known in the art and will not be explained further in this example.

Each of the various text regions perform a function similar to the character positions—they visibly display text. The text regions, however, usually display text or data strings stored in a memory of the device. For example, text region 330 may contain a string of characters which represents a textual instruction to the user of a device. As illustrated in FIG. 4, the text string “Input contact name” appears in text region 330 as defined in FIG. 3. This text string provides a textual instruction to the user. Such text strings may be stored in the memory of the device and called as needed depending upon the state of the device.

Similarly, the overlaid text region 332 and the broken text region 334 may also display text strings stored in memory. FIG. 4 illustrates two examples. Overlaid text region 332 displays the text string “Use ---------- for letters” where each “-” represents a blank space within the text string. The blank spaces represented by each “-” are included in the text string at the location where it is desirable to overlay an icon. In this manner, a text string is displayed with the overlying icons which correspond to input keys “2” and “3” as illustrated by icon-based input cue 420 in FIG. 4. The combination of the icons corresponding to input keys “2” and “3” and the text string displayed in text region 332 and icon regions 340 creates icon-based input cue 420. The broken text region 334 is similar to the overlaid text region 332 in that it allows the display of graphics or icons with the text message appearing in broken text region 334. A text string used to fill a broken text region 334 is actually a plurality of text strings combined with icon regions to form a message. In FIG. 4, the text string “Use” is combined with the corresponding icons representing the forward and reverse selection keys in icon region 342 and a second text string “for position” to form icon-based input cue 430. An appended icon-based cue (not shown) may also be formed by combining an icon with the front or tail end of a text string.

A text region may also substitute for the character position 320 region. In such an embodiment an active text region (not shown) similar to text region 330 including an active cursor could both display data retrieved from a memory and accept input from a user as described with reference to the character positions 320. One advantage of using a text region for data input, such as those described, is availability of different font types, sizes, and appearances.

The icon regions display the icons stored in the device memory and thereby provide the icon-based input cues of the present invention. Icon regions 340, as illustrated in FIG. 3, overlie a overlaid text region 332. The combination of the icons displayed in icon regions 340 and the text message displayed in overlaid text region 332 create icon-based input cue 420 for a user. Similarly, larger icons may be displayed in large icon regions 342 to provide additional icon-based cues.

As illustrated in FIG. 4, the display of icons corresponding to input keys in icon regions 340 inform a user of the input keys which may be used to enter a letter in the active cursor 322 position in the character positions 320. The display of the selection key icons in the large icon region 342 informs a user of the selection keys which may be used to position the active cursor 322 within the character positions 320. It is understood that icons may be displayed alone or with corresponding text to provide an icon-based input cue. Also, the icons displayed are typically graphical representations of the actual command keys, selection keys, or input keys available to a user.

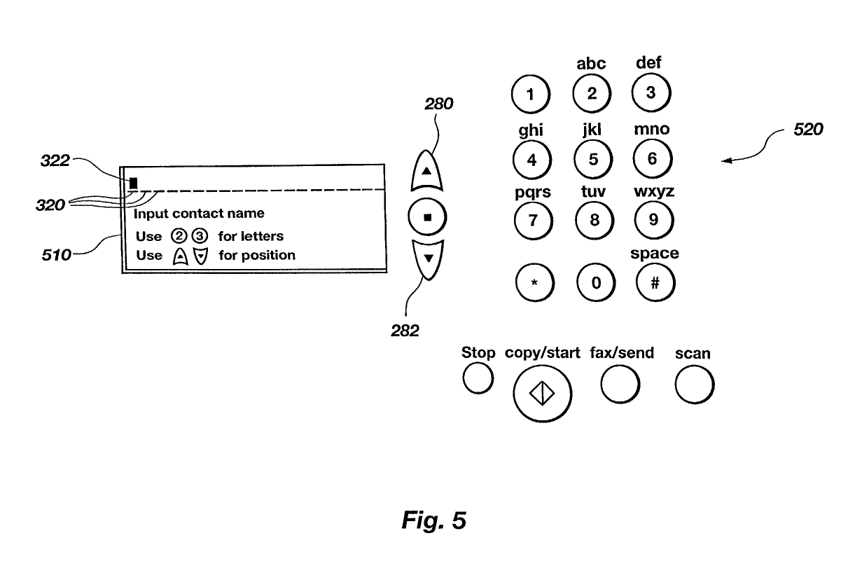

To better understand the present invention, an example of its use is described with reference to FIGS. 5 and 6. A facsimile/copy/scan machine having a display 510 and control panel 520 similar to that of FIG. 2, is illustrated in FIG. 5. This example describes the entry of a contact name into the memory of the facsimile portion of the device.

Having chosen to enter a contact name into the memory of the device, the user is visually prompted with the options available to them. A textual instruction “Input contact name” is displayed in a text region on the display. In addition, two icon-based input cues 420 and 430 are also visible. The first icon-based input cue 420 informs the user that they may use the number buttons of the standard numeric keypad to enter the letters of the contact's name. The second icon-based input cue 430 informs the user that the forward and reverse selection keys may be used to choose the active cursor position. Faced with these icon-based input cues, the user is informed as to the operation of the device without the need for additional written materials such as an instruction manual. Furthermore, the presence of icon-based input cues, rather than no cues or just text-based cues, helps to facilitate multilingual use of the device employing the present invnetion.

As illustrated in FIG. 5, the active cursor 322 appears in the first character position. As indicated by the second icon-based input cue 430, a user may use the forward and reverse selection keys to move the active cursor. Selection of the forward selection key 280 advances the active cursor by one character position 320. Similarly, selection of the reverse selection key 282 moves the active cursor one position backward. However, if the active cursor is in a first position, the selection of the reverse selection key 280 would have no effect on moving the active cursor.

Selection of one of the input keys, shown as number keys in this example, on the keypad causes the placement of a letter in the character position occupied by the active cursor. For example, selection of the number “5” places the letter “j” in the position of the active cursor because the letters “j” “k” and “1” correspond to the number “5”. Pressing the number “5” a second time without advancing the active cursor changes the letter in the active cursor position to “k”. Similarly, pressing the number “5” a third time displays the letter “1” in the active cursor position. Pressing the number key a fourth time displays the number “5” in the active cursor position. In this manner, a user is able to scroll through the letters associated with a given number on the numeric keypad until the desired letter appears in the active cursor position. Once the desired letter is in the proper position, the active cursor is advanced by choosing the appropriate forward or reverse selection key. It is understood that additional schemes could be used to position a letter or number in a character position using the number keys. Likewise, additional or different input keys associated with the device may also be used.

Illustrated in FIG. 6 is the display 510 of FIG. 5 following a series of input key and selection key operations performed by a user. Initially, the active cursor is positioned in the first character position. A user pressing the number “5” selects the letter “j” which is displayed in the first character position. Selection of the forward selection key advances the active cursor to the next character position. Selecting the number “6” three times displays the letter “o” in the second character position. The active cursor is advanced to the next character position by the forward selection key. The letter “h” is displayed in the third character position by pressing the number “4” twice. The active cursor is advanced again by selecting the forward selection key. The letter “n” is displayed in the fourth character position by pressing the number “6” twice and the active cursor is advanced by selecting the forward selection key. The display 510 illustrated in FIG. 6 is a representative example of what the display of FIG. 5 would look like after these actions are carried out by the user. The name “john” is displayed in the first four character positions and the active cursor appears in the fifth character position.

The entry of letters, numbers, and other characters may be entered in different ways according to the programming of the particular device. It is understood that the manner in which the information is entered into the device does not affect the present invention, other than by changing the associated icon-based cues displayed on the device. In other words, no matter what scheme is used, icon-based input cues may be displayed to instruct a user of the necessary operations that must be performed to use the device.

In addition to the icon-based input cues displayed in FIGS. 5 and 6, an additional icon-based input cue, such as “Press ‘ok’ to save name” where the ‘ok’ is an icon corresponding to the ‘ok’ selection key could be displayed (not shown). In this manner, additional icon-based instructions are visible to the user.

The present invention, therefore, provides the user with icon-based input cues which were heretofore unavailable to users. The icon-based input cues improve the user-friendliness of the devices with which they are incorporated by providing visual cues rather than strictly textual based cues.

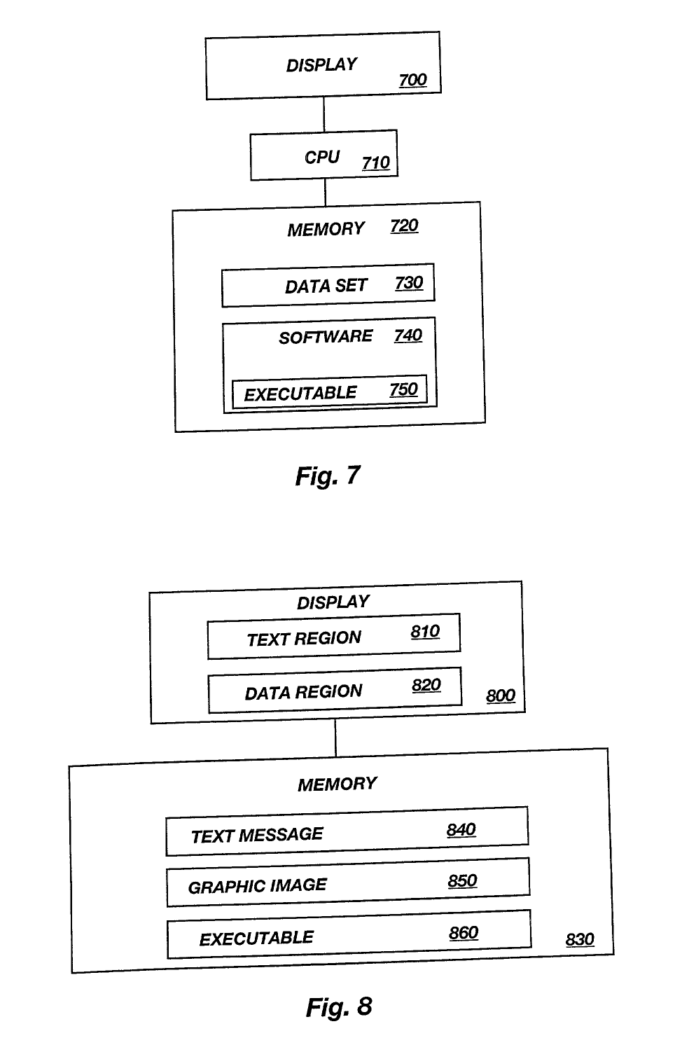

To better understand the present invention the interaction of a display with functional components is illustrated in FIGS. 7 and 8. FIG. 7 provides a block diagram of a display 700 in communication with a central processing unit (CPU) 710. The CPU 710 is also in communication with a memory 720. A data set 730 is stored in the memory 720. The data set 730 may include textual or graphical data as well as additional information which may be displayed on the display 700. Furthermore, a software program 740 including at least one executable function 750 is stored in the memory 720. The executable function 750 displays the data set 730 as an image or images on the display 700.

Similarly, FIG. 8 illustrates a block diagram of another embodiment of a display 800 in communication with additional functional componentry. A memory 830 in communication with the display 800 may store at least one text message 840, at least one graphic image 850, and at least one executable function 860. Text messages 840 may include words, phrases, or instructions to be displayed on the display 800. Graphical images 850 stored in the memory 830 may include images of control, selection or input keys and the like. The executable function 860 retrieves a text message 840 or graphical image 850 from the memory 830 and displays it on the display 800. The display 800 includes both text regions 810 and graphic regions 820 for displaying text messages 840 or graphical images 850 retrieved from the memory 830.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method of improving the user-friendliness of a device having a display and function keys which comprises displaying icon-based input cues on a display of said device to inform a user of said function keys available for use by said user.

2. The method of claim 1 wherein displaying icon-based input cues on a display of said device further comprises displaying graphical images of any active function keys on said display.

3. The method of claim 1 wherein displaying icon-based input cues on a display of said device further comprises displaying -graphical images of any active function keys in combination with a text string on said display.

4. The method of claim 1 wherein displaying icon-based input cues on a display of said device further comprises:
storing graphical images of each of said function keys in a memory of said device; determining if any of said function keys are active; and
displaying said graphical images of any active function keys on said display of said device.

5. The method of claim 4 further comprising:
storing text strings in said memory of said device, each of said text strings corresponding to at least one function key; and
displaying said text strings for each active function key in combination with said graphical image of the same active function key on said display of said device.

6. The method of claim 5 wherein displaying said text strings for each active function key in combination with said graphical image of the same active function key on said display of said device further comprises interposing said graphical image of each active function key in said text string corresponding to the same active function key on said display.

7. The method of claim 5 wherein displaying said text strings for each active function key in combination with said graphical image of each active function key on said display of said device further comprises combining portions of said text strings for each active function key with said graphical image of the same active function key

8. The method of claim 5 wherein displaying said text strings for each active function key in combination with said graphical image of the same active function key on said display of said device comprises combining more than one graphical image with a single text string on said display.

9. A method of using an icon-based input cue with a device having a display and at least one function key, comprising:
determining if said at least one function key is active; and
displaying an icon-based input cue on said display corresponding to said function key if said function key is active.

10. The method of claim 9 wherein displaying said icon-based input cue on said display corresponding to said function key further comprises:
retrieving a graphical image of said function key from a memory of said device; and
displaying said graphical image as an icon on said display of said device.

11. The method of claim 10, further comprising:
retrieving a text message corresponding to said function key from a memory of said device; and
displaying said text message in combination with said icon on said display of said device.

12. The method of claim 11 wherein displaying said text message in combination with said icon on said display of said device comprises displaying said icon interposed with said text message.

13. The method of claim 10 wherein displaying said text message in combination with said icon on said display of said device further comprises displaying at least a second icon in combination with said text message, said second icon corresponding to a function key of said device.

14. The method of claim 9 further comprising displaying a plurality of icon-based input cues on said device, each of said icon-based input cues corresponding to at least one active function key.

15. The method of claim 9 further comprising:
receiving a command from a user;
removing said icon-based input cue from said display;
determining if said at least one function key is active; and
displaying a new icon-based input cue on said display corresponding to said function key if said function key is active.

16. An icon-based input cue for a device comprising:
a graphical image of a function key of said device displayed on a display of said device.

17. The icon-based input cue of claim 16 wherein said graphical image of said function key is stored in a memory of said device as an icon.

18. The icon-based input cue of claim 16 further comprising a second graphical image of a second function key of said device displayed in combination with said graphical image of said function key.

19. The icon-based input cue of claim 16 further comprising a text string displayed in combination with said graphical image of said function key of said device.

20. The icon-based input cue of claim 19 wherein said graphical image of said function key of said device is interposed with said text string.

21. A display system, comprising:
at least one functional key;
a display device to display text and graphical images;
a memory in communication with said display device;
at least one graphical image for storing as data in said memory, said at least one graphical image corresponding to said at least one functional key; and
at least one executable function for retrieving said at least one graphical image stored as data from said memory and display said at least one graphical image on said display device.

22. The display system of claim 21, wherein said display device is a bit map display.

23. The display system of claim 22, wherein said bit map display is a grayscale liquid crystal display.

24. The display system of claim 22, wherein said bit map display is a color active matrix display.

25. The display system of claim 21, further comprising a software program for controlling said at least one executable function.

26. A printer display system comprising:
a central processing unit;
a display device in communication with said central processing unit;
a memory in communication with said central processing unit;
at least one data set for storing in said memory; and
a software program for storing in said memory including at least one executable function for displaying an image represented by said at least one data set on said display device.

27. The printer display system of claim 26, further comprising an input device in operable communication with said central processing unit for communicating data to said memory.

28. The printer display system of claim 27, wherein said input device is one of the group consisting of a floppy disk drive, a hard disk drive, an optical disk drive, a digital video disk drive, a compact disc drive and a memory card.

29. A display system, comprising:
a display device having at least one text region for displaying text and at least one graphic region to display graphical images;
a memory in communication with said display device;
at least one text message for storing in said memory;
at least one graphical image for storing in said memory; and
at least one executable function for storing in said memory for retrieving said at least one text message or said at least one graphical image from said memory and to display said at least one text message or said at least one graphical image on said display device.

30. The display system of claim 29, further comprising:
at least one function key;
a graphical image of said at least one function key for storing as data in said memory; and
an executable function for storing in said memory for retrieving said graphical image of said at least one function key from said memory and for displaying said graphical image of said at least one function key on said display device if said at least one function key is active.
